(19) United States
(12) Patent Application Publication
(10) Pub. No.: US 2008/0251330 A1
(43) Pub. Date: Oct. 16, 2008

(54) Brake Shoe

(76) Inventor: Masaaki Kobayashi, Obu (JP)

Correspondence Address: BUCHANAN, INGERSOLL & ROONEY PC, POST OFFICE BOX 1404, ALEXANDRIA, VA, 22313-1404, US

(21) Appl. No.: 11/963,903

(22) Filed: Dec. 24, 2007

(30) Foreign Application Priority Data
Jan. 31, 2007 (JP) 2007-021736

(51) Int. Cl. F16D 65/04

(52) U.S. Cl. 188/250 B

(57) ABSTRACT

A brake shoe is proposed which includes a lining containing a rubber of the type which becomes ebonite when vulcanized. An elastic interlayer is disposed between the lining and an adhesive layer through which the lining is bonded to the shoe body. The interlayer serves as a stress relief layer, thereby preventing the lining from peeling off the shoe body when the brake shoe is subjected to thermal history.

### CROSS REFERENCE TO RELATED APPLICATIONS

This application is based on and claims priority under 35 U.S.C. sctn. 119 with respect to Japanese Patent Application No. 2007-21736 filed on Jan. 31, 2007, the entire content of which is incorporated herein by reference.

### BACKGROUND OF THE INVENTION

This invention relates to a brake shoe which is suitable as a brake shoe of a vehicle drum brake, and particularly a brake shoe which is high in mass-productivity, inexpensive, and high in performance and reliability.

Brake shoes for use e.g. in vehicle drum brakes comprise a shoe body and a lining adhesively bonded to the shoe body. Such a lining comprises a substrate, lubricant, friction adjuster, binder and filler.

Such brake shoes and technologies relating thereto are disclosed e.g. in JP Patent publications 2003-156090A, 3677235B, 10-196695A and 2001-163993A (which are hereinafter referred to as Patent documents 1-4, respectively). Patent document 1 disclose a composition for friction materials which contains a water-soluble thickener and water, and a method of producing a strip of a friction material having a predetermined thickness by kneading the above composition into clay in a mixer, and extruding the clay through an extruder. Patent document 2 discloses a method in which the shoe body and a lining that has been formed in advance are integrally formed so as to form the lining into a final shape and simultaneously, the lining is cured, thereby bonding the lining to the shoe body.

Patent document 3 proposes to shorten the time for forming and bonding the lining by heating and cooling the shoe body. Patent document 4 proposes to provide a friction material sheet having a uniform composition by adding fibrous Zonolite of a predetermine size to a composition for the friction material.

In Patent document 1, the brake shoe is manufactured by providing a strip of a friction material by extruding and forming the kneaded composition for the friction material, cutting the strip to a predetermined length to provide a blank plate, forming the blank plate into a curved plate, and bonding the curved plate to a weight body corresponding to a shoe body. In this method, since the step of forming the blank plate and the step of bonding the blank plate to the weight body are carried out separately, the number of manufacturing steps is large.

In the method disclosed in Patent document 2, the step of forming the lining before bonding the lining to the shoe body increases the number of pressing steps.

In the method disclosed in Patent document 3, although the time for forming and bonding can be shortened by cooling the shoe body, the addition of the cooling step lowers productivity.

In Patent document 4, the method of manufacturing the friction material sheet is not specifically disclosed. As described in paragraph

of this document, the method of forming the composition alone, or the method of forming the sheet on the brake base plate or clutch base plate as a covering layer would not improve productivity.

### SUMMARY OF THE INVENTION

An object of this invention is to provide a brake shoe of which the lining is less likely to peel off the shoe body, which can be manufactured with high mass-productivity and at a low cost, and of which the lining can be bonded to the shoe body with high reliability.

To achieve this object, the present invention provides a brake shoe comprising an arcuate shoe body, an arcuate lining provided on an outer periphery of the shoe body, the lining containing a rubber in the form of ebonite as a binder, and an interlayer having elasticity and laminated on one side of the lining, the interlayer being disposed between the lining and the shoe body and bonded to the shoe body through an adhesive layer. The interlayer has preferably a thickness in the range of 50 to 500 μm.

The brake shoe can be manufactured by a method comprising the steps of cutting a blank sheet for a lining which has been formed by extruding or calendering into a strip of a predetermined length, superposing the strip on an arcuate shoe body, forming and bonding the strip to the shoe body, and subjecting the integrally formed lining and shoe body to heat treatment.

In this method, since the lining is formed on the shoe body by the dies, tapers are formed at both ends thereof which allow easy release of the lining from the dies.

With the brake shoe according to the present invention, the interlayer, which is disposed between the lining and the adhesive layer, serves as a stress relief layer for reducing stress applied to the lining due to a difference in thermal shrinkage between the lining and the adhesive layer. Thus, even though a lining is used containing a rubber in the form of ebonite as a binder, which tends to shrink more markedly than conventional linings which contain a binder mainly comprising a phenolic resin, the lining never develop cracks, so that the lining can be bonded to the shoe body with high reliability.

By using a lining containing a rubber in the form of ebonite as a binder, the brake shoe can be manufactured by a method which is inexpensive and high in mass-productivity (method in which the lining is joined to the shoe body without forming the lining beforehand).

If the interlayer is too thin, it does not sufficiently serve the purpose of reducing stress, and if it is too thick, the lining cannot be fixed with sufficient strength to the shoe body. Thus, preferably, the interlayer has a thickness in the range of 50 to 500 μm.

### BRIEF DESCRIPTION OF THE DRAWINGS

Other features and objects of the present invention will become apparent from the following description made with reference to the accompanying drawings, in which:

FIG. 1 is a side view of a brake shoe embodying the invention;

FIG. 2 is a front view of the brake shoe of FIG. 1;

FIG. 3 is a schematic sectional view taken along line X-X of FIG. 1;

FIG. 4 shows the manufacturing steps of the brake shoe according the present invention;

FIG. 5 schematically shows the calendering step; and

FIG. 6 shows the steps of a conventional manufacturing method of a brake shoe.

### DETAILED DESCRIPTION OF THE PREFERRED EMBODIMENTS

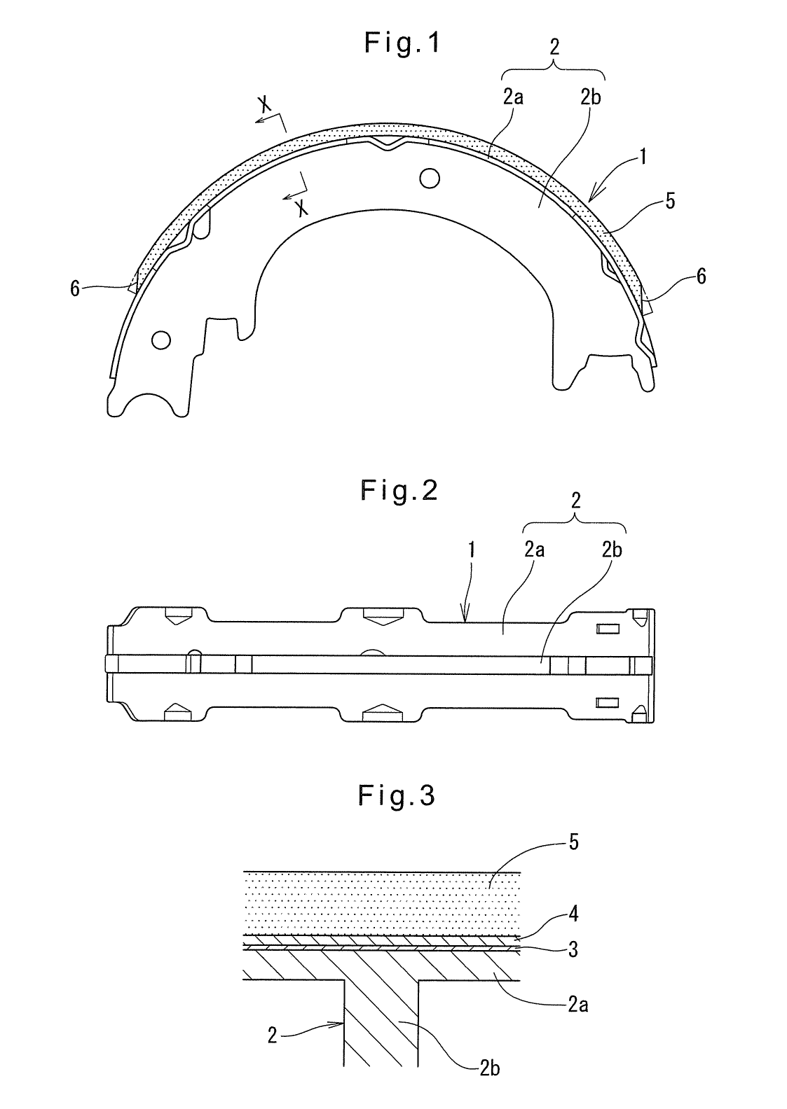

Now the brake shoe embodying the present invention is described with reference to FIGS. 1 to 4. As is apparent from FIGS. 1 and 2, the brake shoe shown is one used in a drum brake. This brake shoe 1 comprises a shoe body 2, and an arcuate lining 5 fixed to the outer periphery of the shoe body 2 through a bonding layer 3 and an interlayer 4 shown in FIG. 3. The shoe body 2 comprises an arcuately bent rim 2a, and a web 2b joined to the inner periphery of the rim 2a. The lining 5 is bonded to the outer periphery of the rim 2a.

The bonding layer 3 is made of a thermosetting resin, typically a phenolic resin. The interlayer 4 is a thin layer, about 50 to 500 μm thick, made e.g. of nitrile rubber (NBR). The interlayer 4 does not become ebonite, and remains elastic after the lining has been hardened by heat treatment.

The lining 5 is made of a composition which is a mixture of a substrate, lubricant, friction adjuster, filler and binder. The substrate, lubricant, friction adjuster and filler used may be ones used in compositions for ordinary friction materials. In compositions for ordinary friction materials, fibrous substrates are used as their substrates, such as metallic fibers, synthetic resin fibers and inorganic fibers. As their lubricants, graphite or the like is used. As their friction adjusters and fillers, metallic oxides, metallic salts (such as barium sulfate) and organic powders (such as cashew dust) are used. The lining 5 according to the present invention may also be made of such materials.

But the binder contained in the lining 5 according to the present invention is not an ordinary binder, but a rubber or a substance mainly comprising a rubber. The rubber may be diene rubber such as butadiene rubber (BR), styrene rubber (SBR), nitrile rubber (NBR), isoprene rubber (IR) and natural rubber (NR).

To 100 parts by weight of such rubber, 20 to 40 parts by weight of sulfur is added. The rubber, which contains such a large amount of sulfur, becomes ebonite and hardens when vulcanized. The lining thus formed is therefore sufficiently heat-resistant and wear-resistant. Such rubber can be added using an ordinary rubber kneading method. For example, it can be added using an open roll, Banbury mixer, pressure kneader or extruder.

A thermosetting resin such as a phenolic resin may be added as an additional binder. In such a case, the content ratio of the rubber and the thermosetting resin (i.e. rubber: thermosetting resin) should be in the range of 100:0 to 50:50, preferably 100:0 to 70:30 in order that the rubber can sufficiently perform its expected function. If the resin content is higher than the rubber content, the effect of the addition of the rubber may be reduced to such an extent that the lining cannot be strongly and integrally bonded to the shoe body.

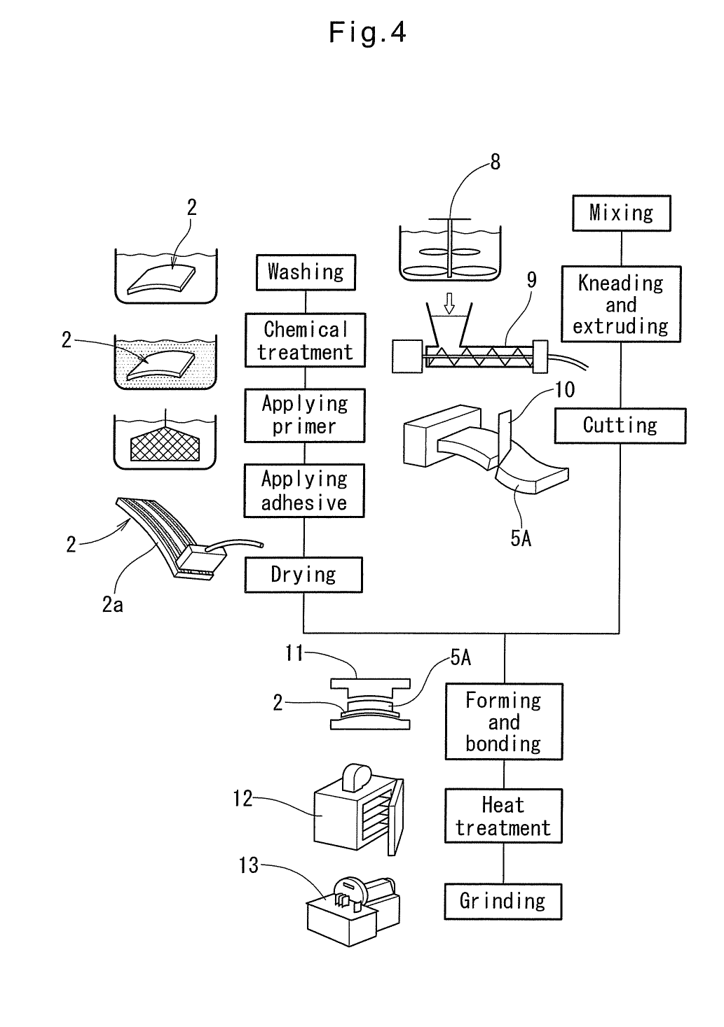

A method of manufacturing this brake shoe is described. As shown in FIG. 4, in preparatory steps, the shoe body 2 is washed, subjected to chemical treatment, and after applying a primer, air-dried (these steps are the same as the manufacturing steps of conventional brake shoes).

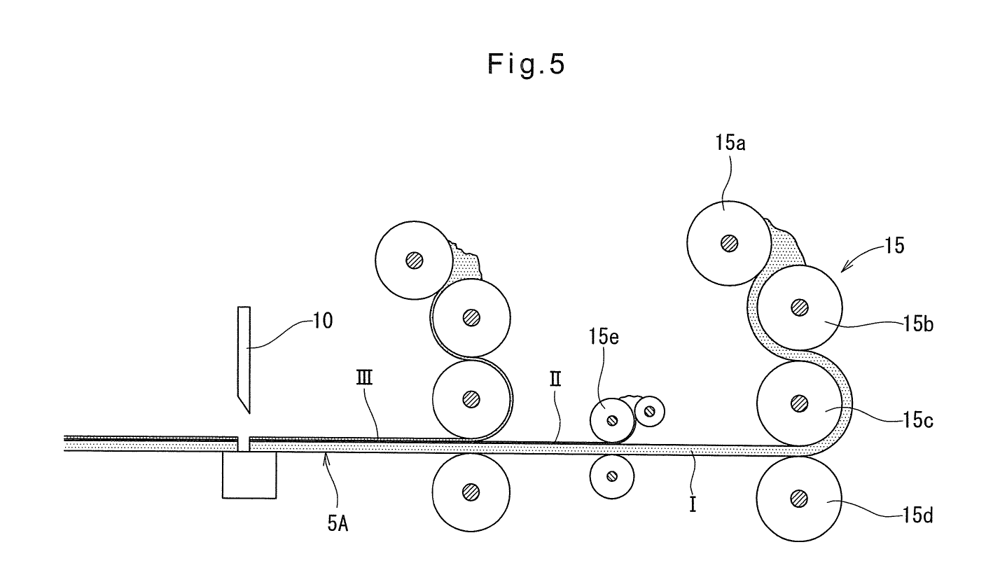

The composition for the lining is prepared by mixing the raw materials in e.g. a mixer 8. The composition thus prepared is formed into a sheet I having a predetermined thickness by kneading and extruding the composition in an extruder 9, or by calendering. The calendering is performed using a calender 15 shown in FIG. 5. The calender 15 shown comprises four rolls 15a to 15d. The composition is fed first between the rolls 15a and 15b, then between the rolls 15b and 15c and finally between the rolls 15c and 15d to form the sheet 1. Material II for the interlayer is laminated on one side of the sheet I in a thin layer, using e.g. an applicator roll 15e. Alternatively, material II may be sprayed onto the sheet I.

Thereafter, material III for the bonding layer is laminated on material II for the interlayer to a desired thickness using rolls similar to the rolls 15a to 15d. A blank sheet 5A is thus obtained.

The blank sheet 5A is then cut to a strip of a predetermined length by a cutter 10 shown in FIG. 4. The strip is then fed to a bonding station where it is bonded to the shoe body. Alternatively, the strip of a predetermined size may be formed by blanking the sheet 5A.

The shoe body 2, which has been treated in the preparatory steps, is set between upper and lower dies of a pressing machine 11. The shoe body 2 and the sheet 5A (strip) are then heated and pressed against each other by the upper and lower dies. In this state, the shoe body 2 serves as a forming die, allowing the flexible sheet 5A to be bent along and brought into close contact with the outer peripheral surface of the rim 2a. Also, heating during forming allows the sheet 5A to be bonded to the shoe body 2.

The thus formed shoe body and the sheet 5A are placed in a furnace 12 and subjected to heat treatment to cure the lining. During this heat treatment, the rubber that has been added to the sheet I becomes ebonite, curing the binder. The lining is thus formed. During this heat treatment, material II for the interlayer is not vulcanized and remains elastic after the heat treatment. After these steps, the lining 5 is finished by grinding with a grinder 13 to provide the finished brake shoe.

Because the binder contained in the lining of the brake shoe according to the invention is a rubber or mainly comprises a rubber, a blank sheet having a predetermined thickness and having stable physical properties is obtainable by extrusion or calendering. Because such a blank sheet is highly flexible before curing, it is possible to bend a predetermined length of a strip (for the lining) obtained by cutting the blank sheet precisely along the arcuate outer peripheral surface of the shoe body without the possibility of cracks in the strip and strongly and integrally bond the strip to the shoe body before curing. This eliminates the necessity to arcuately bend the liner beforehand, which in turn reduces the number of forming steps as well as the number of grinding steps of the liner, so that it is possible to improve productivity. The reduction in the number of manufacturing steps leads to reduced labor and energy consumption.

The interlayer, which is disposed between the adhesive layer and the lining, serves as a stress relief layer. That is, the interlayer reduces stress applied to the lining due to a difference in thermal shrinkage between the lining and the adhesive layer, thereby preventing cracks in the lining. This ensures reliability of the adhesive bond between the lining and the shoe body.

If an ordinary soft rubber is used as a binder, it is difficult to ensure heat resistance and wear resistance. But by using a rubber of the type that becomes ebonite when vulcanized, it is possible to impart sufficient heat resistance and wear resistance to the lining.

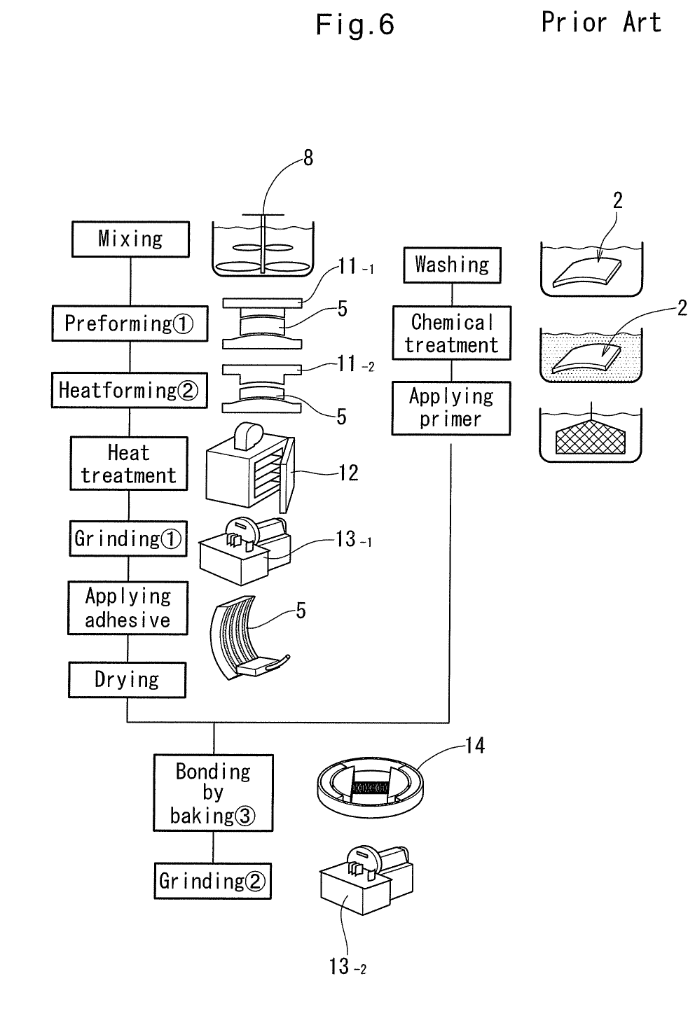

For comparison purposes, FIG. 6 shows a method of manufacturing a conventional ordinary brake shoe. The preparatory steps for the shoe body of this conventional method are exactly the same as those of the method according to the invention. But the steps for manufacturing the lining are clearly different from those of the inventive method. In particular, the conventional method needs the preparatory step of forming the lining 5 with a pressing machine 11-1, the subsequent heat forming step using a pressing machine 11-2, and the step of bonding by baking the lining to the shoe body with a bonding machine 14. Thus, three pressing steps are needed. Also, this conventional method needs two grinding steps, i.e. the step of grinding the inner and outer surfaces of the lining before the lining is bonded to the shoe body with a grinder 13-1, and the finish-grinding step using a grinder 13-2.

In contrast, the brake shoe according to the invention can be manufactured by simultaneously bending the lining and bonding the lining to the shoe body as shown in FIG. 4. Thus, the inventive method needs only one pressing step. Also, because it is not necessary to grind the lining before bonding, the inventive method needs only one grinding step.

As shown in FIG. 1, when the lining 5 is formed by the pressing machine, tapers 6 are formed at both ends thereof so that the lining is easily releasable from the dies. It is well known that by removing the edges of the lining at both ends thereof by chamfering, brake squeal can be effectively suppressed. The tapers 6 serve this purpose too.

What is claimed is:

1. A brake shoe comprising an arcuate shoe body, an arcuate lining provided on an outer periphery of said shoe body, said lining containing a rubber in the form of ebonite as a binder, and an interlayer having elasticity and laminated on one side of said lining, said interlayer being disposed between said lining and said shoe body and bonded to said shoe body through an adhesive layer.

2. The brake shoe of claim 1 wherein said interlayer has a thickness in the range of 50 to 500 μm.
